(19) United States
(12) Patent Application Publication
(10) Pub. No.: US 2010/0272049 A1
(43) Pub. Date: Oct. 28, 2010

(54) MOBILE COMMUNICATION DEVICE AND COMMUNICATION METHOD

(75) Inventors: Chao-ping TUNG, Flower Mound, TX (US); Feng MO, Lewisville, TX (US)

Correspondence Address: Sychip, Inc.;c/o Keating & Bennett, LLP, 1800 Alexander Bell Drive, Reston, VA, 20191, US

(73) Assignee: MURATA MANUFACTURING CO., LTD., Nagaokakyo-shi (JP)

(21) Appl. No.: 12/766,980

(22) Filed: Apr. 26, 2010

Related U.S. Application Data
(60) Provisional application No. 61/173,298, filed on Apr. 28, 2009.

(51) Int. Cl. H04W 4/00

(52) U.S. Cl. 370/329

(57) ABSTRACT

A mobile communication device for communicating with a second communication device includes a first communication interface arranged to establish a first communication session with the second communication device, a second communication interface arranged to establish a second communication session with the second communication device, and a controller arranged to control, based upon information determined or measured by the mobile communication device, the first communication interface and the second communication interface to simultaneously establish the first communication session and the second communication session and to simultaneously transmit identical data packets to the second communication device using the first communication session and the second communication session.

### BACKGROUND OF THE INVENTION

1. Field of the Invention

The present invention relates to handover methods without the use of a network-based handover-controller. More specifically, the present invention relates to mobile communication devices and communication methods that use such handover methods.

2. Description of the Related Art

Known mobile communication devices establish communication sessions for communicating media streams through one or more communication interfaces over a communication network using the communication network's protocol. For wireless communication networks, the communication interface is usually a radio, and for voice calls, the media stream is a voice media stream. For example, known mobile communication devices can include a wide area network (WAN) radio for communicating over a wide-area or cellular wireless network using, for example, the GSM protocol and a wireless local area network (WLAN) radio for communication over a local area network using, for example, the WiFi protocol.

A diverse range of broadband wireless access technologies, including, for example, GSM, UMTS, CDMA2000, WiFi, WiMAX, Mobile-Fi, and WPANs, is available and is experiencing ongoing development. Wireless communication devices that include more than one wireless interface require the ability to switch among the various wireless interfaces during the course of a communication session. Devices, such as laptops with Ethernet and wireless interfaces, similarly require the ability to switch between wired and wireless interfaces.

The process of transferring a media stream of a first communication session to a second communication session is typically referred to as a handover, or a handoff. A handover can be within a communication network or can be from a first communication network to second communication network. A handover from a first communication network to second communication network can include a change of protocols and can include keeping the same protocol.

In conventional handover methods, a network-based handover-controller is often used to gather information about the radio transmissions to and from the mobile communication device and is used to make the handover decisions. Network-based handover-controllers can be used to make handover decisions for handovers within a communication network, handovers from a first communication network to second communication network, handovers with a change of protocols, and handovers with the same protocol.

For example, in a cellular network that uses the same protocol throughout the cellular network, it is possible to perform a handover within the communication network. When communicating voice media streams as in a cellular network, it is important to maintain voice call continuity during the handover. As the user of a mobile phone moves from an area of a first base station to an area of a second base station, the network-based handover-controller can instruct the mobile communication device to establish simultaneous communication sessions through the same cellular radio with the first base station and the second base station for communicating the same voice media stream.

For example, as shown in FIG. 1, it is also possible to perform a handover from a first communication session established over a wide-area or cellular wireless network to a second communication session established over a wireless local area network. In such a handover, a mobile communication device changes the interface the mobile communication device uses to access the communication networks, e.g., handover among WLAN, UMTS/GPRS, and WiMAX. Conventionally, a network-based handover-controller that includes a media independent handover function (MIHF) is used to gather information about the radio transmission to and from the mobile communication device that includes a plurality of interfaces, e.g. radios, and is used to make the handover decisions in accordance with the gathered information, as shown in FIG. 1.

While the mobile communication device communicates a voice media stream during a first communication session through an active interface, the network-based handover-controller instructs the mobile communication device to establish a new communication session over an inactive interface that then can communicate the same voice media stream. After establishing this new communication session, the network-based handover-controller then instructs the mobile communication device to terminate the old communication session. Thus, the mobile communication device can continue to communicate with a second communication device over the new communication session with minimal interruption.

In the hard handover shown in FIG. 2A, the media stream between a first mobile communication device and a second communication device during a first communication session is terminated before establishing a second communication session that is then used to continue communicating the media stream between the first mobile communication device and the second communication device. Hard handovers can be desirable because they can be performed with simple communications systems. However, hard handovers also have a problem in which noticeable interruptions or delays in communication between the first mobile communication device and the second communication device can be recognized by users of the first mobile communication device and the second communication device.

### SUMMARY OF THE INVENTION

In preferred embodiments of the present invention, the handover decisions are preferably made by the mobile communication device without the need for a network-based handover-controller. The result is that the method of the preferred embodiments of the present invention can be implemented over existing cellular or WiMax networks and WLAN, for example, much more easily than conventional methods. In addition, the preferred embodiments of the present invention allow mobile communication device vendors to have much more freedom to design innovative handover decision algorithms than are possible using conventional methods.

According to a preferred embodiment of the present invention, a mobile communication device for communicating with a second communication device includes a first communication interface arranged to establish a first communication session with the second communication device, a second communication interface arranged to establish a second communication session with the second communication device, and a controller arranged to control, based upon information determined or measured by the mobile communication device, the first communication interface and the second communication interface to simultaneously establish the first communication session and the second communication session and to simultaneously transmit identical data packets to the second communication device using the first communication session and the second communication session.

The controller is preferably arranged to control the first communication interface and the second communication interface to terminate one of the first communication session and the second communication session in response to the occurrence of a predetermined condition. The predetermined condition is preferably elapse of a predetermined time period. The predetermined condition is preferably sending a termination signal to the second communication device. The information generated or measured by the mobile communication device is preferably sensing that a signal strength of the one of the first communication session and the second communication session has fallen under a specific threshold for a predetermined period of time.

The first communication interface and the second communication interface are preferably arranged to simultaneously receive identical data packets from the second communication device. The controller is preferably arranged to discard one of the identical data packets received from the second communication device. The controller is preferably arranged to combine the identical data packets received from the second communication device. At least one of the first communication interface and the second communication interface preferably is a wireless radio. The first communication interface and the second communication interface preferably use different protocols.

According to a preferred embodiment of the present invention, a communicating method includes providing a first communication device, which includes a first communication interface arranged to establish a first communication session with a second communication device and a second communication interface arranged to establish a second communication session with the second communication device, and based upon information determined or measured by the first communication device, simultaneously establishing the first communication session and the second communication session and simultaneously transmitting identical data packets to the second communication device using the first communication session and the second communication session.

The communication method preferably further includes terminating one of the first communication session and the second communication session in response to the occurrence of a predetermined condition. The predetermined condition is preferably elapse of a predetermined time period. The predetermined condition is preferably sending a termination signal to the second communication device. The information generated or measured by the first communication device is preferably sensing that a signal strength of the one of the first communication session and the second communication session has fallen under a specific threshold for a predetermined period of time.

A communication method preferably further includes simultaneously receiving identical data packets from the second communication device. The communication method preferably further includes discarding one of the identical data packets received from the second communication device. The communication method preferably further includes combining the identical data packets received from the second communication device. At least one of the first communication interface and the second communication interface preferably is a wireless radio. The first communication interface and the second communication interface preferably use different protocols.

Other features, elements, characteristics, and advantages of the present invention will become more apparent from the following detailed description of preferred embodiments of the present invention with reference to the attached drawings.

### BRIEF DESCRIPTION OF THE DRAWINGS

FIG. 1 shows an overview of communication networks according to the conventional art.

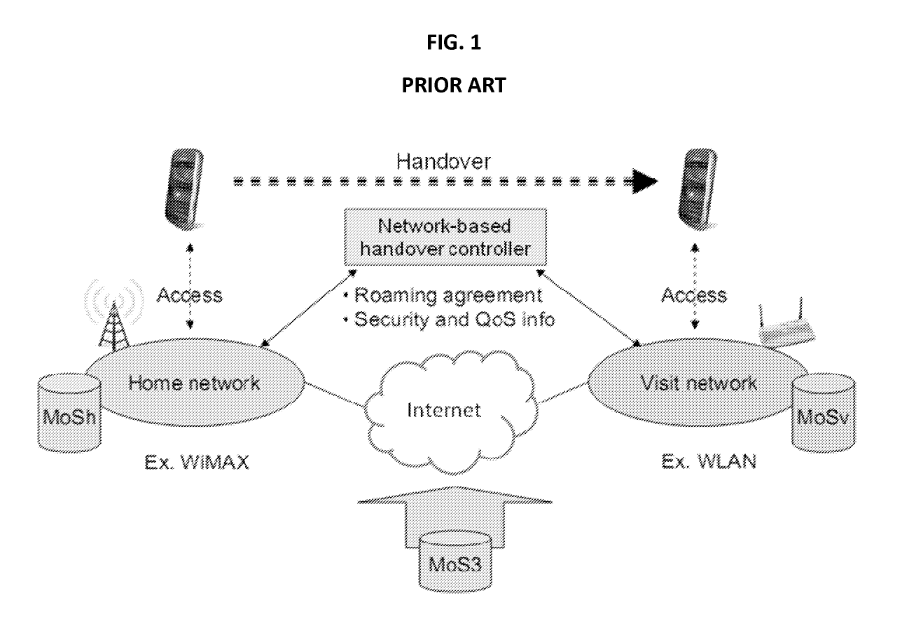

FIGS. 2A and 2B show two the types of handover processes that can be used to transfer an ongoing call or data session from one channel to another channel.

FIG. 3 shows an overview of communication networks according to a preferred embodiment of the present invention.

FIG. 4 shows media session flows according to a preferred embodiment of the present invention.

FIG. 5 shows an overview of a communication system in accordance with a preferred embodiment of the present invention.

FIG. 6 shows a mobile communication device in accordance with a preferred embodiment of the present invention.

### DETAILED DESCRIPTION OF PREFERRED EMBODIMENTS

There are many devices today that contain different radios for communication using different protocols, such as WiFi, WIMAX, GSM, CDMA, etc. Different network-centric methods have been developed to support handovers between different communication networks using these protocols. Preferred embodiments of the present invention are arranged to perform handovers between devices that include multiple interfaces that are capable of transmitting data simultaneously over the multiple interfaces. The handovers of the preferred embodiments of the present invention include handovers within a communication network, handovers from a first communication network to second communication network, handovers with a change of protocols, and handovers with the same protocol. The handovers of the preferred embodiments of the present invention also include handovers from wireless interface to wireless interface, handovers from wired interface to wired interface, handovers from wireless interface to wired interface, and handovers from wired interface to wireless interface.

An example of the general requirements of preferred embodiments of the present invention include:
1) The mobile communication device includes at least two different types of radios, e.g., WiMAX and WLAN radios;
2) It is assumed WiMAX has good coverage outdoor and WLAN has good signal strength indoor;
3) Due to the poor penetration of WiMAX in the office environment, it is desired for the mobile communication device to handover to WLAN;
4) A soft handover is preferred to reduce voice stream interruption; and
5) It is not required that WiMAX and WLAN are from the same network service provider.
   The preferred embodiments of the present invention use a simple and elegant handset-centric method.

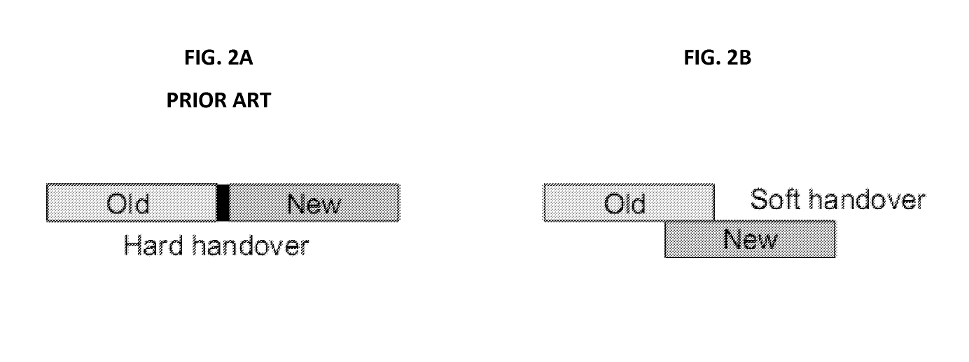

FIG. 2B shows a soft handover. In a soft handover, while a media stream between the first mobile communication device and the second communication device during a first communication session is active, a second communication session is established between the first mobile communication device and the second communication device. When the second communication session is established, the media stream between the first mobile communication device and the second communication device is transferred to the second communication session from the first communication session. Finally, after the media stream between the first mobile communication device and the second communication device has been transferred to the second communication session, the first communication session is terminated such that the second communication session is the only connection between the first mobile communication device and the second communication device. Soft handovers are generally preferred in communication systems where it is desirable for communication to be maintained without any noticeable interruptions or delays. Also, soft handovers have the benefit of being less likely to result in a dropped connection than hard handovers. However, soft handovers are generally more complicated to perform and require slightly more sophisticated communications systems.

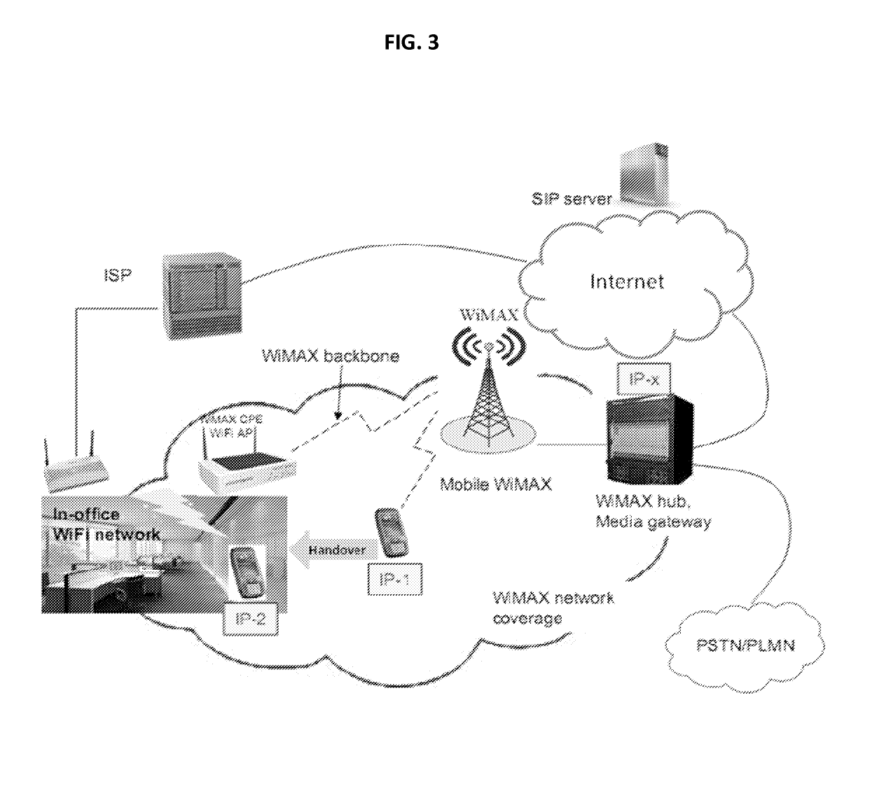

An example of a communications system according to a preferred embodiment of the present invention is shown in FIG. 3. In FIG. 3, a first communication device (which could be, for example, a wireless phone, a computer, a media gateway, or any other desirable communications device) including interfaces IP-1 and IP-2 communicates with a second communication device (which could also be, for example, a wireless phone, a computer, a media gateway, or any other desirable communications device) including interface IP-x. The first communications device can establish a first communication session over a first communication network (for example, a WiMAX network) between the interface IP-1 and interface IP-X. Then, while the first communication session is active, the first communications device handovers to a second communication network (for example, an in-office WiFi network). The first communication device then establishes a second communication session over a second communication network between the interface IP-2 and interface IP-x. Accordingly, the first communication device can be connected to the second communication device through two simultaneously communication sessions over two separate networks, as shown in FIG. 3.

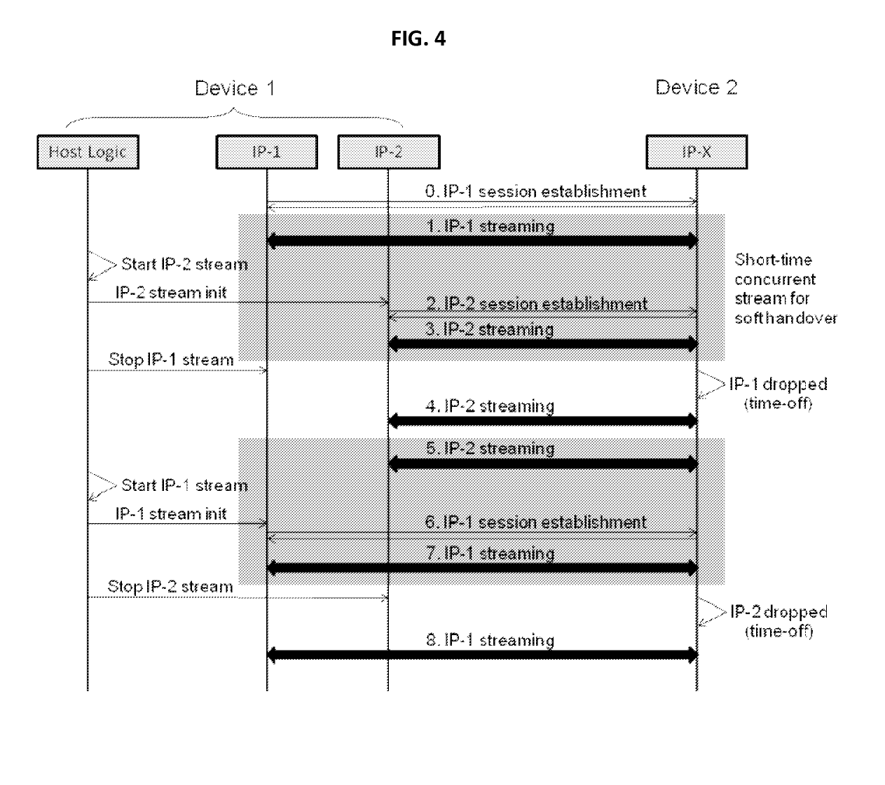

A handover method according to the preferred embodiment of the present invention is shown in FIG. 4. This handover method starts with the establishment of a communication session between first interface IP-1 of the first communication device and interface IP-x of a second communication device. After the establishment of this first communication session, a media stream is communicated between the interface IP-1 and the interface IP-x. Then, while the first communication session is active, the first communication device initiates a second communication session between a second interface IP-2 of the first communication device and the interface IP-x of the second communication device.

After this second communication session had been established, the first communication device begins transmitting an additional media stream that is identical to the media stream transmitted between the interface IP-1 and the interface IP-x. The second communication device can discard the extra duplicate data packets or can combine the duplicate data packets from the two identical media streams.

At a later time, the first communication device chooses to terminate the first communication session between the interface IP-1 and the interface IP-x. In this preferred embodiment of the present invention, the first communication device independently chooses to perform this termination based on a condition of the first communication session, which could be determined by, for example, signal strength, an error rate, a timeout, or other suitable condition.

After the termination of the first communication session by the first communication device, the second communication device terminates the first communication session based upon the determination by the second communication device that the channel is no longer active. However, as shown in FIG. 4, the communication between the first communication device and the second communication device is able to continue without interruption. Thus, the changing of the media stream between the first communication session and the second communication session is performed as a soft handover.

While FIG. 4 shows the first communication device making all of the handover decisions (the decisions to terminate specific communication sessions), it should be understood that it would also be possible to have the second communication device make these handover decisions, if so desired. As shown near the bottom of FIG. 4, it is possible that the first communication device re-establish the connection between the interface IP-1 and the interface IP-x whenever needed so that the connection is available to perform another handover if and when it becomes necessary.

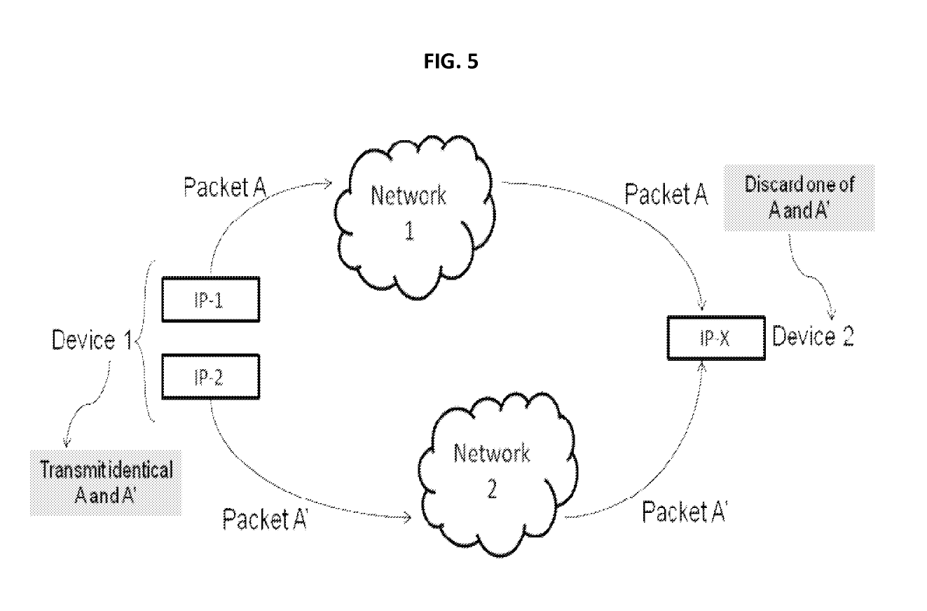

FIG. 5 shows another example of a communications system according to a preferred embodiment of the present invention. In FIG. 5, a first communications device (which could be, for example, a wireless phone, a computer, a media gateway, or any other desirable communications device) including interface IP-1 and interface IP-2 can communicate with a second communication device (which could also be, for example, a wireless phone, a computer, a media gateway, or any other desirable communications device) including interface IP-x.

According to the preferred embodiment of the present invention shown in FIG. 5, a first communication session is established between the first communication device and the second communication device with a fixed IP address (e.g., a media gateway or a mobile IP client). The first communication device, which includes multiple interfaces, e.g. different radios from communicating with different wireless protocols, would choose one particular interface (for example, interface IP-1) to establish the first communication session between the first communication device and the second communication device, e.g., using SIP and SDP.

Once the first communication session is established, the second communication device's address(es) (for example, interface IPx) for the first communication session is(are) fixed, and the first communication device transmits/receives media streams (e.g., RTP or SRTP streams) to that(those) particular interface(s) of the second communication device. The second communication device would initially send data packets of the media stream to the address(es) indicated during establishment of the first communication session. Thus, the media stream will be established to have endpoints between interface IP-1 and interface IP-x).

After establishment of the first communication session, the first communication device can send duplicate data packets to the second communication device from any other its interfaces. For example, if the first communication device also has another valid IP address for the interface IP-2, for example, for a different radio from the radio used for the interface IP-1, then the first communication device can also transmit through interface IP-2 the same media stream that it is transmitting through the interface IP-1 from that to IP-x. That is, as shown in FIG. 5, the first communication device can simultaneously transmit a first media stream including packet A from interface IP-1 to interface IP-x and a second media stream including packet A′ from interface IP-2 to interface IP-x. Packet A preferably contains the same encoded media stream that is identical to packet A′.

Accordingly, the second communication device simultaneously receives a first media stream from interface IP-1 and a second media stream from interface IP-2. Because the same data packets are being transmitted over both of interfaces IP-1 and IP-2, the second communication device can simply discard any extra duplicated packets sent from the first communication device. That is, as shown in FIG. 5, the second communication device can discard one of the duplicate data packets A and A′ when the duplicate data packets A and A′ are received from interfaces IP-1 and IP-2. In discarding one of the data packets A and A′, the second communication device must first judge if the packets that it is receiving are duplicate data packets. Because the first and second media streams have the same content and are also both received at about the same time, the second communication device is able to determine that the first and second data streams come from the same device, the first communication device. In addition, the first communication device could provide the data packets with indentifying information, such as using the same RTP header information. Accordingly, the second communication device is able to determine when it has received duplicate data packets so that the second communication device can then discard one of these duplicate data packets. Alternatively, the second communication device could combine the two data packets into one data packet, rather than discarding excess data packets. All of these steps are preferably performed by the second communication device, without a network-based handover-controller.

On the other side of the exchange, the second communication device would automatically duplicate the second communication device's data packets to every IP address from which the second communication device has received a valid data packet so that the first communication device can perform similar duplicate data packet operations to those described above with respect to the second communication device. While this process is not explicitly shown in FIG. 5, it is essentially the same process as shown in FIG. 5 but with the directions of the flow of the packets reversed.

Additional authentication steps or authentication keys obtained during communication session establishment can be used to validate the new data packets transmitted to the first communication device over an additional interface (e.g., SRTP using same key, RTP payload carrying the info, new SIP exchange, etc). Because the same data packet is being sent, the first communication device would simply discard any extra duplicate data packets received from the different interfaces. As with the second communication device, the first communication device can determine when data packets come from the same device because these data packets will have been transmitted from the same IP address. Again, these steps are preferably performed by the first communication device, without a network-based handover-controller.

In preferred embodiments of the present invention, because the first communication device can choose to establish and terminate transmission from a particular interface at any time, it is desirable for the second communication device to determine when duplicate data packets to a particular address can and should be terminated. This can be accomplished by using a simple timeout mechanism in which after no data packets have been received from a specific interface for a predetermined period of time and in which the second communication device will terminate transmissions to the specific interface. Alternatively, the second communication device could use any other additional mechanism (e.g., the first communication device sends signal to the second communication device, measuring a signal strength between the first communication device and the second communication device) to determine when a communication session between the first communication device and the second communication device should be discontinued.

An example of a preferred embodiment of the present invention where the first communication device is a wireless phone including interfaces IP1 and IP2 and the second communication device using interface IPx is shown below. The arrows indicate the direction of the media flow.

Session establishment for IP1 and IPx:

| | | |
|---|---|---|
| IP1 | ← | IPx |
| IP1 | → | IPx |

Device 1 switches to IP2 and stops sending from IP1

| | | | |
|---|---|---|---|
| IP1 | ← | IPx | |
| IP2 | → | IPx | |
| IP2 | ← | IPx | (Device 2 replicates data packets |
| | | | to IP2 after receiving from IP2) |

IP1 is dropped by second communication device after timeout on
IP1 stream

| | | |
|---|---|---|
| IP2 | → | IPx |
| IP2 | ← | IPx |

Device 1 switches to IP1 and IP2

| | | | |
|---|---|---|---|
| IP2 | ← | IPx | |
| IP2 | → | IPx | |
| IP1 | → | IPx | |
| IP1 | ← | IPx | (Device 2 replicates data packets |
| | | | to IP1 after receiving from IP1) |

Device 1 switches to IP1 only and stops sending from IP2

| | | |
|---|---|---|
| IP2 | ← | IPx |
| IP1 | ← | IPx |
| IP1 | → | IPx |

IP2 dropped by second communication device after timeout on IP2 stream

| | | |
|---|---|---|
| IP1 | ← | IPx |
| IP1 | → | IPx |

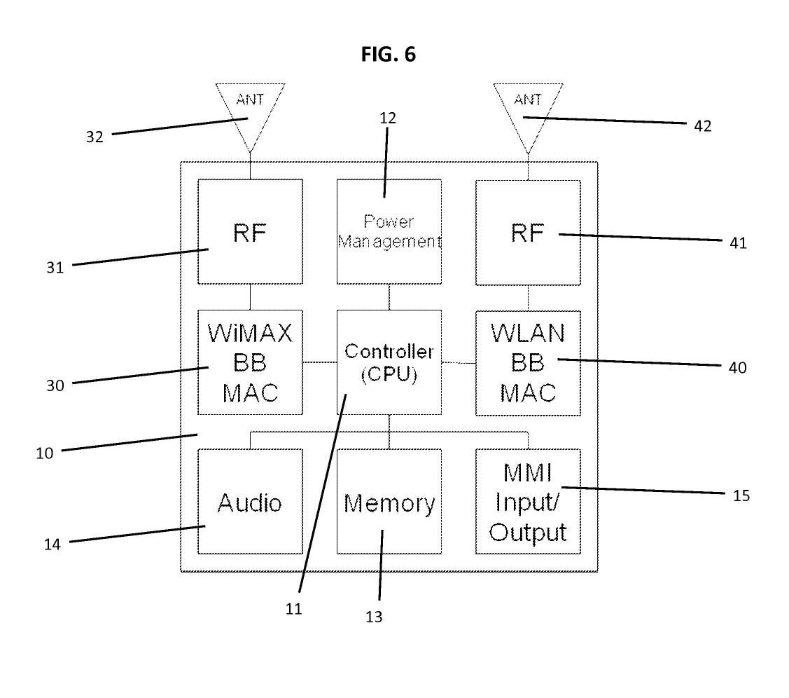

FIG. 6 shows an example of a mobile communication device 10 according to a preferred embodiment of the present invention. In the example shown in FIG. 6, the mobile communication device 10 is able to communicate over WiMAX and WLAN networks. The mobile communication device 10 includes a controller 11, which is typically a central processing unit (CPU), that is programmed to control the various functions of the mobile communication device 10, including the handover methods of the preferred embodiments of the present invention discuss above. The controller 11 is connected to a power management module 12 that provides power for the mobile communication device 10 and includes, for example, a battery. The controller 11 is also connected to memory module 13 that provides electronic information storage for the mobile communication device 10. The controller 10 is also connected to input/output modules, including, for example, audio module 14 and man-to-machine-interface (MMI) input/output module 15.

The mobile communication device 10 also includes a WiMAX wireless radio that enables the mobile communication device 10 to communicate over a WiMAX network and a WLAN wireless radio that enables the mobile communication device 10 to communicate over WLAN network. The WiMAX wireless radio includes a WiMAX baseband (BB) and medium access control (MAC) module 30 that is connected to an antenna 32 through an RF module 31. The WLAN wireless radio includes a baseband (BB) and medium access control (MAC) module 40 that is connected to an antenna 42 through an RF module 41. Both the WiMAX BB MAC module 30 and the WLAN BB MAC module 40 are connected to the controller 11.

The soft handover method of preferred embodiments of the present invention requires that the second communication device be able to handle two concurrent RTP streams for the same communication session for a short period of time during the soft handover. The device needs to respond to the two interfaces, IP-1 and IP-2 over two different communication networks during simultaneously communication sessions with two separate media streams. The second communication device may be a media gateway (MGW). While this type of MGW behavior is non-standard, it could be supported by configuration changes in the software of the MGW.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A mobile communication device for communicating with a second communication device comprising:
a first communication interface arranged to establish a first communication session with the second communication device;
a second communication interface arranged to establish a second communication session with the second communication device; and
a controller arranged to control, based upon information determined or measured by the mobile communication device, the first communication interface and the second communication interface to simultaneously establish the first communication session and the second communication session and to simultaneously transmit identical data packets to the second communication device using the first communication session and the second communication session.

2. The mobile communication device of claim 1, wherein the controller is arranged to control the first communication interface and the second communication interface to terminate one of the first communication session and the second communication session in response to the occurrence of a predetermined condition.

3. The mobile communication device of claim 2, wherein the predetermined condition is elapse of a predetermined time period.

4. The mobile communication device of claim 2, wherein the predetermined condition is sending a termination signal to the second communication device.

5. The mobile communication device of claim 1, wherein the information generated or measured by the mobile communication device is sensing that a signal strength of the one of the first communication session and the second communication session has fallen under a specific threshold for a predetermined period of time.

6. The mobile communication device of claim 1, wherein the first communication interface and the second communication interface are arranged to simultaneously receive identical data packets from the second communication device.

7. The mobile communication device of claim 6, wherein the controller is arranged to discard one of the identical data packets received from the second communication device.

8. The mobile communication device of claim 6, wherein the controller is arranged to combine the identical data packets received from the second communication device.

9. The mobile communication device of claim 1, wherein at least one of the first communication interface and the second communication interface is a wireless radio.

10. The mobile communication device of claim 1, wherein the first communication interface and the second communication interface use different protocols.

11. A communicating method comprising:
providing a first communication device including:
a first communication interface arranged to establish a first communication session with a second communication device; and
a second communication interface arranged to establish a second communication session with the second communication device; and
based upon information determined or measured by the first communication device, simultaneously establishing the first communication session and the second communication session and simultaneously transmitting identical data packets to the second communication device using the first communication session and the second communication session.

12. The communication method of claim 11, further comprising terminating one of the first communication session and the second communication session in response to the occurrence of a predetermined condition.

13. The communication method of claim 12, wherein the predetermined condition is elapse of a predetermined time period.

14. The communication method of claim 12, wherein the predetermined condition is sending a termination signal to the second communication device.

15. The communication method of claim 11, wherein the information generated or measured by the first communication device is sensing that a signal strength of the one of the first communication session and the second communication session has fallen under a specific threshold for a predetermined period of time.

16. The communication method of claim 11, further comprising simultaneously receiving identical data packets from the second communication device.

17. The communication method device of claim 16, further comprising discarding one of the identical data packets received from the second communication device.

18. The communication method of claim 16, further comprising combining the identical data packets received from the second communication device.

19. The communication method of claim 11, wherein at least one of the first communication interface and the second communication interface is a wireless radio.

20. The communication method of claim 11, wherein the first communication interface and the second communication interface use different protocols.
